(19) United States
(12) Patent Application Publication
(10) Pub. No.: US 2016/0202217 A1
(43) Pub. Date: Jul. 14, 2016

(54) METHODS AND APPARATUS FOR ACOUSTIC ASSESSMENT OF FLUID CONDUITS

(71) Applicants: Pipelines 2 Data (P2D) Limited, Aberdeen (GB); HYDRASON SOLUTIONS LIMITED, Edinburgh (GB)

(72) Inventors: Steve Mayo, Aberdeen (GB); Nigel Money, Aberdeen (GB); Chris Capus, Glasgow (GB); Yan Pailhas, Glasgow (GB)

(21) Appl. No.: 15/077,766

(22) Filed: Mar. 22, 2016

Related U.S. Application Data
(63) Continuation of application No. 14/411,472, filed on Dec. 26, 2014.

(30) Foreign Application Priority Data
Jun. 28, 2012 (GB) 1211515.0

(51) Int. Cl. G01N 29/34; G01N 29/265

(52) U.S. Cl. CPC G01N 29/348; G01N 29/265; G01N 2291/101

(57) ABSTRACT

A method of and apparatus for assessing a condition of a fluid conduit is described. The method comprises providing a measurement apparatus comprising at least one wideband acoustic transducer internally or externally of a fluid conduit, and transmitting a wideband acoustic signal from the measurement apparatus to excite at least a portion of the fluid conduit. A wideband acoustic signal is received in the measurement apparatus to obtain a wideband acoustic data set; the wideband acoustic data set is analysed to assess the condition of the fluid conduit. The wideband acoustic signal comprises frequencies in the range of approximately 10 kHz to approximately 150 kHz. Applications include detecting or assessing a layer or deposit on an interior of the fluid conduit and assessing a physical condition of the fluid conduit. Water ingress into an annulus of a multiple layer conduit (such as a flexible riser) may be detected.

### CROSS REFERENCE TO RELATED APPLICATIONS

This application is a continuation of the earlier U.S. Utility Patent Application entitled “METHODS AND APPARATUS FOR ACOUSTIC ASSESSMENT OF FLUID CONDUITS,” application Ser. No. 14/411,472, filed Dec. 26, 2014, which is a U.S. National Stage of International Patent Application Number PCT/US2013/048785, filed Jun. 28, 2013, which claims priority to United Kingdom Patent Application No. 1211515.0, filed Jun. 28, 2012, the disclosures of which are hereby incorporated entirely herein by reference.

### BACKGROUND

1. Technical Field

The present invention relates to methods and apparatus for the acoustic assessment of fluid conduits or their features, particularly but not exclusively to methods and apparatus assessing the condition of features of surface, subsea or subterranean pipelines, risers including marine and/or flexible risers, tubing including subterranean well tubing, and other fluid conduits used in the hydrocarbon exploration, production and transportation industries.

Aspects of the invention are methods and apparatus which use acoustic techniques for the assessment and monitoring of the internal condition of fluid conduits, including the build-up and deposition of scale, sand, waxes and other materials on the interior surface of conduits. Alternative aspects of the invention are methods and apparatus which use acoustic techniques for the assessment, monitoring and inspection of the physical condition of a fluid conduit including defects, wall thickness, damage, holes, cracks and corrosion of a conduit or its layers.

2. State of the Art

Ultrasound transducers have been used in pipeline pigging applications to measure or map the profile of the inner diameter of a pipeline using single frequency pulses.

Wideband acoustic measurement techniques, which may be referred to as bio-sonar acoustic measurement techniques have been used in applications to detect and/or characterise buried objects. Examples are described in Y. Pailhas et al. (2010) (reference [1]) and P. Moore et al. (reference [2]).

WO 2007/123418 describes an acoustic method and apparatus for detecting a hydrate presence in a hydrocarbon pipeline. The technique relies on acoustic resonance frequencies of the pipeline walls, which imposes limitations on the application of the method to the detection or assessment of a wide range of fluid conduit conditions and on the manner in which the apparatus can be deployed.

It is amongst the aims and objects of the invention to provide a method of assessing a fluid conduit condition which is improved with respect to prior art methods and apparatus for acoustic detection. It is another aim of invention to apply bio-inspired acoustic pulses to the assessment of fluid conduit conditions. Further aims and objects of the invention will become apparent from the following description.

### SUMMARY

According to a first aspect of the invention there is provided a method of assessing a condition of a fluid conduit, the method comprising:
providing a measurement apparatus comprising at least one wideband acoustic transducer;
transmitting a wideband acoustic signal from the measurement apparatus to excite at least a portion of the fluid conduit;
receiving a wideband acoustic signal in the measurement apparatus to obtain a wideband acoustic data set; and
analysing the wideband acoustic data set to assess the condition of the fluid conduit; wherein the wideband acoustic signal comprises frequencies in the range of approximately 10 kHz to approximately 150 kHz.

In the context of the description, the term “assessing the condition of a fluid conduit” is used to generally to refer to the overall state of the flow path defined by fluid conduit (primarily the effective flow area of the conduit), including one or more features of its internal condition which may be affected for example by build-up and deposition of scale, sand, waxes and other materials on the interior surface, and its inherent physical condition which may include the presence of defects, damage, holes, cracks, wall thickness and corrosion of the conduit or a part thereof.

The wideband acoustic signal may comprise a lower frequency of approximately 10 kHz, and an upper frequency of approximately 150 kHz, and may comprise a distribution of frequencies between the upper and lower frequencies.

The method may comprise providing a measurement apparatus internally of the fluid conduit. Alternatively, the method may comprise providing the measurement apparatus externally of the fluid conduit.

Preferably, the method comprises transmitting a wideband acoustic signal from the measurement apparatus, through a fluid which couples the measurement apparatus to at least a portion of the fluid conduit. The method may therefore be a non-contact method, in which a transmission transducer does not physically contact the fluid conduit directly.

The measurement apparatus may comprise a transmission wideband acoustic transducer and a receiving wideband acoustic transducer. Alternatively, the wideband acoustic signal may be transmitted and received from a single wideband acoustic transducer.

Preferably, the measurement apparatus comprises a plurality of acoustic transducers, and most preferably comprises a plurality of pairs of transmitting/receiving wideband acoustic transducers.

Preferably, the wideband acoustic transducer comprises a composite transducer. The wideband acoustic transducer preferably has a low Q-factor, and may in preferred embodiments have a Q-factor of less than 5.0. In particular embodiments the Q-factor is less than 2.0 and more preferably is less than 1.5.

The wideband acoustic transducer is preferably selected to have a high transmit and/or receive sensitivity. Preferably, the efficiency of the wideband acoustic transducer is greater than 50%, and more preferably is greater than 65%.

Preferred embodiments of the invention use a plurality of wideband acoustic transducers with similar, substantially identical, or identical specifications as defined above.

The method may comprise transmitting a wideband acoustic signal wideband acoustic signal comprises frequencies in the range of approximately 10 kHz to approximately 150 kHz.

The method may comprise transmitting a wideband acoustic signal comprising a frequency chirp. Preferably, the method comprises transmitting a wideband acoustic signal comprising a plurality of frequency chirps. Preferably, the method comprises transmitting a wideband acoustic signal comprising a plurality of stacked frequency chirps. The transmitted wideband acoustic signal may therefore comprise a complex-stacked chirped signal.

The frequency chirps may comprise down chirps. Alternatively or in addition the frequency chirps may comprise up chirps.

In one example, the wideband acoustic signal comprises a first chirp having a first frequency range, and a second chirp having a second frequency range. The second frequency range is preferably different from the first frequency range, and may be for example slightly higher than the first frequency range.

Preferably the first and second chirps overlap in time, and they may overlap for greater than 50% of the duration of the first chirp. More preferably the first and second chirps overlap for greater than 70% of the duration of the first chirp, and may overlap for greater than 80% of the duration of the first chirp. In a particular embodiment the first and second chirps overlap for around 90% of the duration of the first chirp.

The method may comprise using beam forming transmission and/or reception techniques. The method may comprise transmitting and/or receiving using high directivity index beams, and may comprise using main beam widths of less than 10 degrees.

Preferably, the method comprises analysing the wideband acoustic data set, by comparing the data set with the database of wideband acoustic data signatures. Preferably, the method comprises analysing the frequency content of the wideband acoustic data set. The method may comprise comparing the frequency content of the wideband acoustic data set with the frequency content of previously acquired acoustic data.

Preferably, analysing the wideband acoustic data set is performed in a computer apparatus executing a computer program. Preferably a computer program comprises software algorithms for the analysis for wideband acoustic signals. The method may comprise of interrogating a database of wideband acoustic data. The wideband acoustic data may be data collected from one or more tests performed on a fluid conduit of known condition.

The method may comprise assessing or detecting the presence of a layer or volume of material in the fluid conduit. The layer or volume of material may be a layer or deposit of material on the inner wall or surface of the fluid conduit. The layer or deposit of material may comprise the build-up and/or deposition of scale, sand, waxes, hydrates, or other solids.

Alternatively, or in addition, the layer or volume of material may be volume of fluid in the fluid conduit. The layer or volume of fluid may be between two layers of a multi-layer fluid conduit, for example in an annulus between adjacent layers. The fluid conduit may be a flexible conduit, for example a flexible riser, and the method may comprise assessing or detecting the presence of a volume of fluid in between different layers in the flexible riser. The method may therefore comprise a method of determining or inspecting the condition of a flexible riser.

The method may comprise analysing the wideband acoustic data set to assess one or more acoustic properties or attributes of the layer or volume of material.

The method may comprise assessing a physical condition of the fluid conduit. The physical condition may comprise the presence of one or defects, damage, holes, cracks, wall thickness and/or corrosion of a conduit or its layers.

The method may comprise analysing the wideband acoustic data set to assess one or more acoustic properties or attributes a physical condition of the fluid conduit.

The fluid conduit may be selected from the group consisting of: surface, subsea or subterranean pipelines, risers including marine and/or flexible risers, tubing including subterranean well tubing.

The fluid conduit may be selected a fluid conduit used in the hydrocarbon exploration, production and transportation industries.

According to a second aspect of the invention there is provided a method of assessing a condition of a pipeline comprising:
providing a measurement apparatus comprising a wideband acoustic transducer;
transmitting a wideband acoustic signal from the measurement apparatus to excite at least a portion of the fluid conduit;
receiving a wideband acoustic signal in the measurement apparatus to obtain a wideband acoustic data set;
analysing the wideband acoustic data set to detect or assess a layer or deposit on the interior of the fluid conduit.

The wideband acoustic signal preferably comprises frequencies in the range of approximately 10 kHz to approximately 150 kHz.

The wideband acoustic signal may comprise a lower frequency of approximately 10 kHz, and an upper frequency of approximately 150 kHz, and may comprise a distribution of frequencies between the upper and lower frequencies.

Embodiments of the second aspect of the invention may include one or more features of the first aspect of the invention or its embodiments, or vice versa.

According to a third aspect of the invention there is provided a method of assessing a condition of a flexible riser comprising:
providing a measurement apparatus comprising a wideband acoustic transducer;
transmitting a wideband acoustic signal from the measurement apparatus to excite at least a portion of the fluid conduit;
receiving a wideband acoustic signal in the measurement apparatus to obtain a wideband acoustic data set;
analysing the wideband acoustic data set to detect or assess a volume of material in an annulus between layers of the flexible riser.

The wideband acoustic signal preferably comprises frequencies in the range of approximately 10 kHz to approximately 150 kHz.

The wideband acoustic signal may comprise a lower frequency of approximately 10 kHz, and an upper frequency of approximately 150 kHz, and may comprise a distribution of frequencies between the upper and lower frequencies.

Embodiments of the third aspect of the invention may include one or more features of the first or second aspects of the invention or their embodiments, or vice versa.

According to a fourth aspect of the invention there is provided a method of analysing data acquired according to any previous aspect of the invention.

According to a fifth aspect of the invention there is provided measurement apparatus for assessing a condition of a fluid conduit, the apparatus comprising:
a body and at least one wideband acoustic transducer disposed on the body; wherein the apparatus is operable to:
transmit a wideband acoustic signal from the at least one transducer into a fluid volume coupled to the at least a portion of the fluid conduit;
receive a wideband acoustic signal at the at least one wideband acoustic transducer to obtain a wideband acoustic data set;
wherein the wideband acoustic signal comprises frequencies in the range of approximately 10 kHz to approximately 150 kHz.

The measurement apparatus may comprise a transmission wideband acoustic transducer and a receiving wideband acoustic transducer. Alternatively, the wideband acoustic signal may be transmitted and received from a single wideband acoustic transducer.

Preferably, the measurement apparatus comprises a plurality of acoustic transducers, and preferably comprises a plurality of pairs of transmitting/receiving wideband acoustic transducers.

Preferably, the wideband acoustic transducer comprises a composite transducer. The wideband acoustic transducer preferably has a low Q-factor, and may in preferred embodiments have a Q-factor of less than 5.0. In particular embodiments the Q-factor is less than 2.0 and more preferably is less than 1.5.

The wideband acoustic transducer is preferably selected to have a high transmit and/or receive sensitivity. Preferably, the efficiency of the wideband acoustic transducer is greater than 50%, and more preferably is greater than 65%.

Preferred embodiments of the invention use a plurality of wideband acoustic transducers with similar, substantially identical, or identical specifications as defined above.

Preferably, the transducer is selected to provide a substantially linear or linear acoustic response.

Embodiments of the fifth aspect of the invention may include one or more features of the first to third aspects of the invention or their embodiments, or vice versa.

According to a sixth aspect of the invention there is provided a method of acquiring data using an apparatus according to the fifth aspect of the invention.

According to a seventh aspect of the invention there is provided a method of assessing a condition of a fluid conduit comprising:
providing a measurement apparatus comprising a wideband acoustic transducer;
transmitting a wideband acoustic signal from the measurement apparatus to excite at least a portion of the fluid conduit;
receiving a wideband acoustic signal in the measurement apparatus to obtain a wideband acoustic data set;
analysing the wideband acoustic data set to assess the condition of the fluid conduit.

Preferably, the method comprises transmitting a wideband acoustic signal with a frequency range between approximately 100 kHz and 2.5 MHz.

In certain embodiments (e.g. where there may be increased signal attenuation), the method comprises transmitting a wideband acoustic signal with a lower frequency range, e.g. between approximately 25 kHz and 1 MHz.

Embodiments of the seventh aspect of the invention may include one or more features of the first to sixth aspects of the invention or their embodiments, or vice versa.

According to an eighth aspect of the invention there is provided a measurement apparatus for assessing a condition of a fluid conduit, the apparatus comprising:
a body and at least one wideband acoustic transducer disposed on the body; wherein the apparatus is operable to:
transmit a wideband acoustic signal from the at least one transducer into a fluid volume coupled to the at least a portion of the fluid conduit;
receive a wideband acoustic signal at the at least one wideband acoustic transducer to obtain a wideband acoustic data set.

Embodiments of the eighth aspect of the invention may include one or more features of the first to seventh aspects of the invention or their embodiments, or vice versa.

### BRIEF DESCRIPTION OF THE DRAWINGS

There will now be described, by way of example only, various embodiments of the invention with reference to the drawings, of which:

FIG. 1 is a schematic representation of an internal fluid conduit measurement apparatus according to a first embodiment of the invention;

FIG. 2 is a schematic representation of an external fluid conduit measurement apparatus according to a second embodiment of the invention;

FIG. 3 is a plot of a bio-inspired wideband acoustic signal, as may be used in preferred embodiments of the invention; and

FIGS. 4A to 6B are plots of bio-inspired wideband acoustic pulses, as may be used in preferred embodiments of the invention.

### DETAILED DESCRIPTION OF PREFERRED EMBODIMENTS

There will now be described, by way of example only, various embodiments of the invention with reference to the drawings, of which:

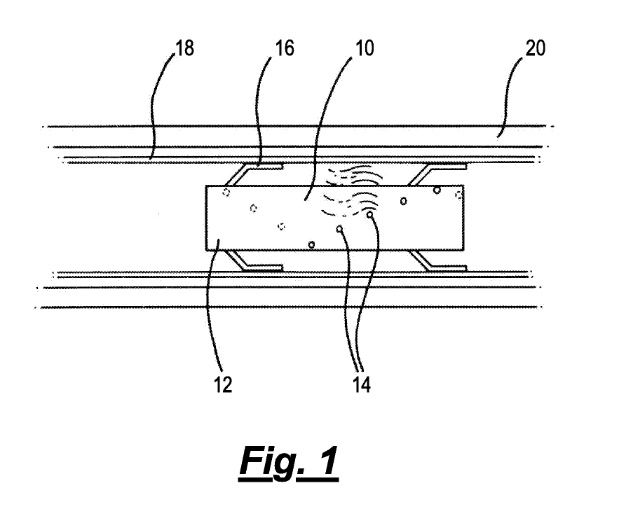

FIG. 1 shows schematically an apparatus 10 according to a first embodiment of the invention which is used to perform an assessment method on a fluid conduit, in this case a hydrocarbon pipeline 20.

The apparatus 10 is configured to be operated inside the pipeline (and is effectively a pipeline pig). The apparatus comprises a body 12 on which are located a plurality of wideband acoustic transducers 14. The transducers are arranged in a helical path on the body. The body is centralised in the pipeline by contact arms 16, which may be measurement callipers. In use, a transmitting transducer 14 transmits a wideband acoustic signal, which may comprise one or more chirps (which may be stacked). The signal is coupled to the pipeline via fluid or slurry contained in the pipeline to excite the pipeline.

In this example, the wideband acoustic signal comprises a lower frequency of approximately 10 kHz, and an upper frequency of approximately 150 kHz, and may comprise a distribution of frequencies between the upper and lower frequencies. In other embodiments, the signal has a frequency range between about 100 kHz and 2.5 MHz. However if increased attenuation is experienced (or expected) a lower frequency range may be employed, e.g. between about 25 kHz and 1 MHz.

The chirps in the signal may have different frequency ranges, selected to overlap to varying degrees (e.g. 50%, 70%, 80%, or 90% in a particular embodiment).

A second transducer receives a return signal from the excited pipeline, and a return data set is collected and stored in internal memory in the apparatus. The return signal is affected by the acoustic properties experienced between transmission and detection, including acoustic properties of the pipeline and a layer 18 deposited on the inside of the pipeline. Analysing the return data set enables the presence of a layer or deposit to be detected by the apparatus. Furthermore, by comparison with acoustic signatures collected from layers or deposits of known thickness, profile and/or composition enables a detected layer or deposit to be characterised. The method therefore enables characteristics of the layer or deposit to be inferred from the detected acoustic wideband signal.

Such analysis can be performed using software algorithms, and the acoustic signatures may be stored as a data set within a database. The frequency content of the return signal can also be analysed, and may be compared with the frequency content of such signature acoustic data sets.

The apparatus 10 may also be used for the detection of defects, damage, holes, cracks, wall thickness and corrosion of the pipeline. Comparison of the received signal with acoustic signatures collected from pipelines with defects, damage, holes, cracks, wall thickness and corrosion enables a detected feature to be characterised.

The analysis may also identify the volume of fluid in the fluid conduit.

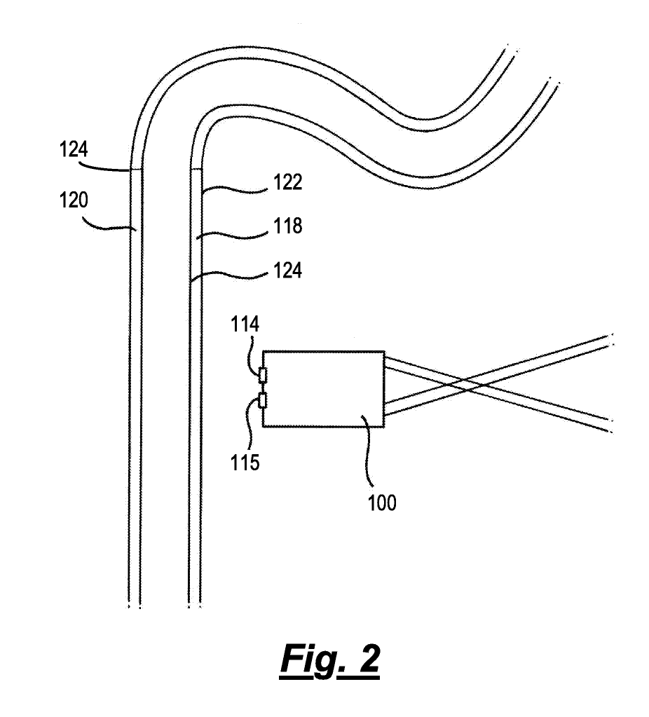

FIG. 2 shows schematically an apparatus 100 according to a second embodiment of the invention which is used to perform an assessment method on a multiple layer fluid conduit, in this case a flexible riser 120.

The apparatus 100 is configured to be operated external to the riser (i.e. in a subsea location). The apparatus comprises a body on which are located a pair of wideband acoustic transducers 114, 115. The apparatus is deployed by an ROV (not shown). In use, a transmitting transducer 114 transmits a wideband acoustic signal, which may comprise one or more chirps. The signal is coupled to the flexible riser by the water column to excite the pipeline.

A second transducer 115 receives a return signal from the excited flexible riser, and a return data set is collected and stored in internal memory in the apparatus or transmitted to a remote location. The return signal is affected by the acoustic properties experienced between transmission and detection, including acoustic properties of the flexible riser and the volume 118 between the outer layer 122 of the riser and an internal layer 124. Analysing the return data set enables the presence of fluid to be detected by the apparatus. The apparatus may therefore be used to identify damage to the flexible riser, indicated by the presence of a flooded annulus. In this case, the flexible riser has a flooded annulus 118 due to water ingress through damaged portions of the flexible riser, with the level of flooding up to the water level 124.

The apparatus 100 may also be used for the detection of defects, damage, holes, cracks, wall thickness and corrosion of the flexible riser. Comparison of the received signal with acoustic signatures collected from pipelines with defects, damage, holes, cracks, wall thickness and corrosion enables a detected feature to be characterised.

In the above examples, a first transducer transmits the wideband acoustic signal, and a second transducer receives the return signal. In practice, it is advantageous if a number of pairs of such transducers are employed. However, it is also envisaged that a wideband acoustic signal may be transmitted and received by the same transducer, or that a number of such dual-purpose transducers may be employed.

The transducers may be composite transducers, may have low Q-factors, e.g. less than 5 (or less than 2, or less than 1.5), and/or may have a high sensitivity, e.g. greater than 50% (or greater than 65%). In practice, a combination of composite and non-composite transducers, transducers of varying Q-factors, and transducers of varying sensitivities, may be employed.

Beam forming techniques can be used in the transmission and/or reception of acoustic signals, and directional (e.g. beam widths of less than 10 degrees) index beams may be employed.

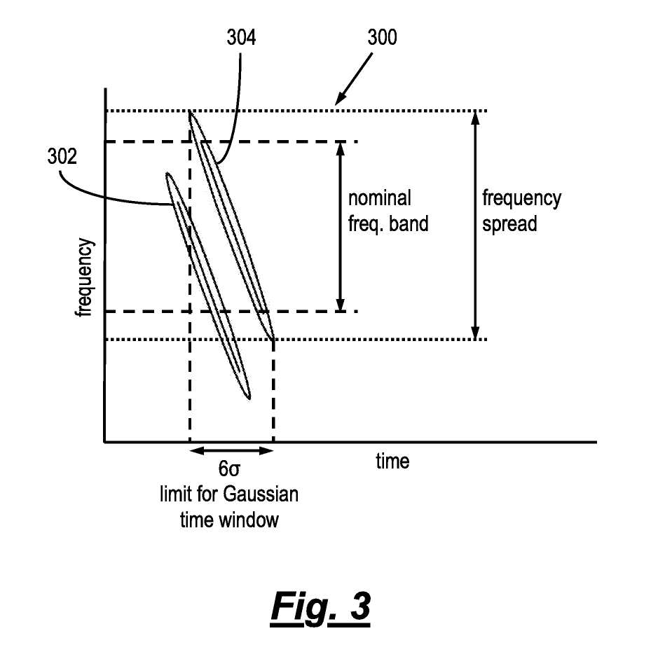

FIG. 3 is a graphical diagram 300 showing an example of the design of a bio-inspired wideband acoustic signal, as may be used in preferred embodiments of the invention. The graph 300 plots frequency against time. The signal comprises a pair of overlapping down chirps 302, 304, which overlap in time to generate the acoustic excitation pulse.

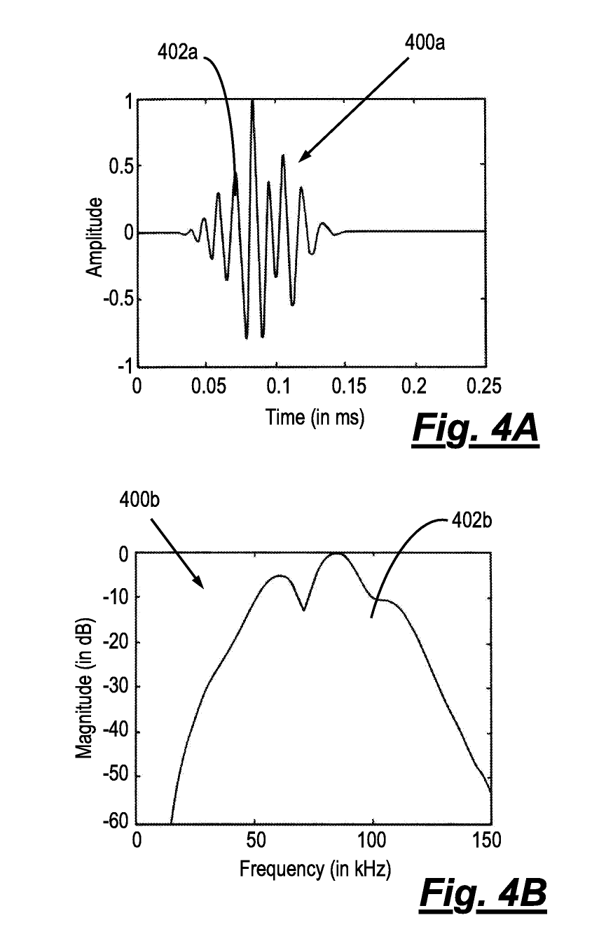

FIGS. 4A to 6B are examples of plots of bio-inspired wideband acoustic pulses, as may be used in preferred embodiments of the invention. In each case, the first plot in each drawing (suffixed “A”) shows the pulse in the time domain, and the second plot (suffixed “B”) shows the pulse in the frequency domain.

In FIGS. 4A and 4B, the plots 400a, 400b, show a wideband acoustic signal 402a, 402b with a frequency range of approximately 15 kHz to about 150kHz, and a distribution of frequencies across that range.

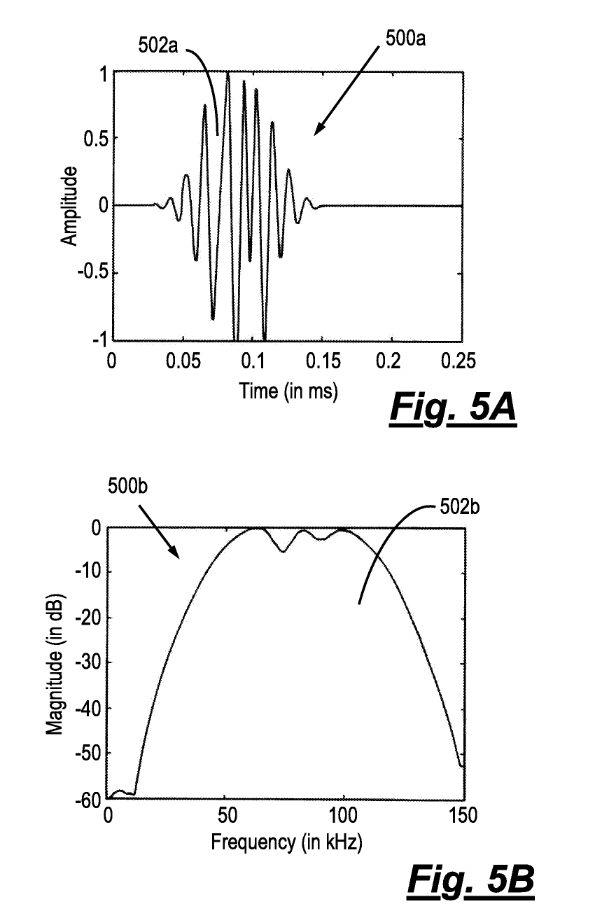

In FIGS. 5A and 5B, the plots 500a, 500b, show a wideband acoustic signal 502a, 502b with a frequency range of approximately 12 kHz to about 150kHz, and a distribution of frequencies across that range.

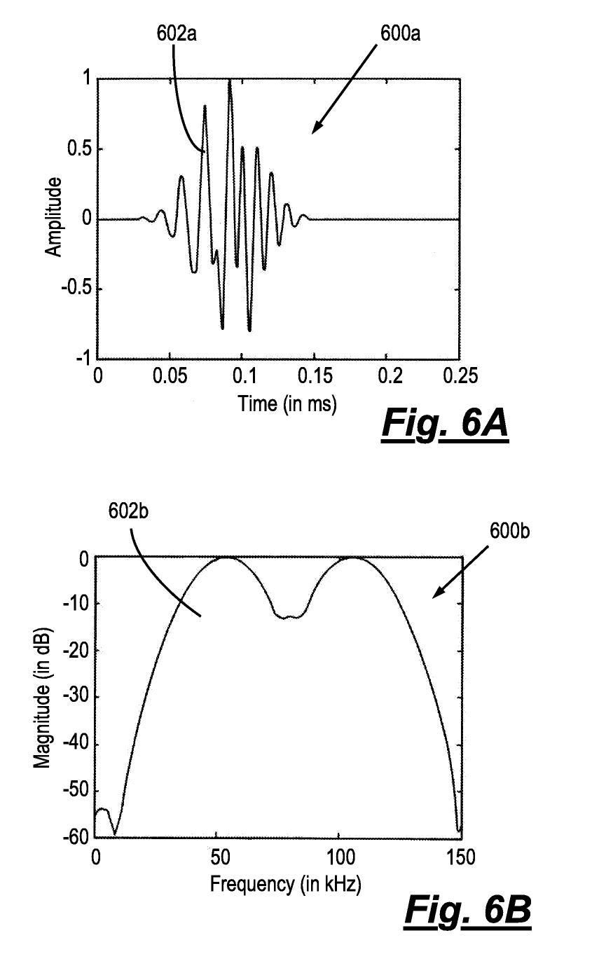

In FIGS. 6A and 6B, the plots 600a, 600b, show a wideband acoustic signal 602a, 602b with a frequency range of approximately 10 kHz to about 150 kHz, and a distribution of frequencies across that range.

The design of wideband acoustic signals in accordance with FIGS. 3 to 6B (i.e. with a frequency range of approximately 10 kHz to about 150 kHz, overcomes limitations of the technique of WO2007/123418, which is reliant on resonant frequencies of pipeline walls. The selection of frequencies in the range of 10 kHz to about 150 kHz facilitates a range of applications to fluid conduit assessment or inspection.

The invention provides a method of and apparatus for assessing a condition of a fluid conduit is described. The method comprises providing a measurement apparatus comprising at least one wideband acoustic transducer internally or externally of a fluid conduit, and transmitting a wideband acoustic signal from the measurement apparatus to excite at least a portion of the fluid conduit. A wideband acoustic signal is received in the measurement apparatus to obtain a wideband acoustic data set; the wideband acoustic data set is analysed to assess the condition of the fluid conduit. The wideband acoustic signal comprises frequencies in the range of approximately 10 kHz to approximately 150 kHz. Applications include detecting or assessing a layer or deposit on an interior of the fluid conduit and assessing a physical condition of the fluid conduit. Water ingress into an annulus of a multiple layer conduit (such as a flexible riser) may be detected.

Various modifications may be made within the scope of the invention as herein intended, and embodiments of the invention may include combinations of features other than those expressly described above. For example, where the apparatus is described above as performing an assessment method on a hydrocarbon pipeline and on a flexible riser, it will be appreciated that the apparatus (and the assessment method) is equally applicable to other fluid conduits including surface, subsea or subterranean pipelines, risers including marine and/or flexible risers, and tubing including subterranean well tubing.

### REFERENCES

[1] Y. Pailhas, C. Capus, K. Brown, and P. Moore, “Analysis and classification of broadband echoes using bio inspired dolphin pulses,” J. Acoust. Soc. Am., vol. 127, no. 6, pp. 3809-3820, 2010.

[2] P. Moore, H. Roitblat, R. Penner, and P. Nachtigall. Recognizing successive dolphin echoes with an integrator gateway network. Neural Networks, 4:701-709, 1991.

[3] WO2007/123418

What is claimed is:

1. A method of assessing a condition of a fluid conduit, the method comprising:
providing a measurement apparatus comprising at least one wideband acoustic transducer;
transmitting a wideband acoustic signal from the measurement apparatus to excite at least a portion of the fluid conduit;
receiving a wideband acoustic signal in the measurement apparatus to obtain a wideband acoustic data set; and
analysing the wideband acoustic data set to assess the condition of the fluid conduit;
wherein the wideband acoustic signal comprises frequencies in the range of approximately 10 kHz to approximately 150 kHz;
and wherein the method comprises providing the measurement apparatus internally of the fluid conduit.

2. The method according to claim 1, wherein the wideband acoustic signal comprises a lower frequency of approximately 10 kHz, and an upper frequency of approximately 150 kHz, and distribution of frequencies between the upper and lower frequencies.

3. The method according to claim 1, comprising detecting or assessing a layer or deposit on an interior of the fluid conduit.

4. The method according to claim 3, comprising detecting or assessing the build-up and/or deposition of scale, sand, waxes, hydrates, or other solids on an interior of the fluid conduit.

5. The method according to claim 1, comprising detecting or assessing a physical condition of the fluid conduit selected from the group consisting of: the presence of defects, damage, holes, cracks, wall thickness and/or corrosion of a conduit or its layers.

6. The method according to claim 5 wherein the measurement apparatus comprises a pipeline pig.

7. The method according to claim 1, wherein the fluid conduit is a multiple-layer fluid conduit, and the method comprises analysing the wideband acoustic data set to detect or assess a volume of material in an annulus between multiple layers of the fluid conduit.

8. The method according to claim 7, wherein the fluid conduit is a flexible riser.

9. The method according to claim 7, comprising detecting or assessing water ingress in the annulus between multiple layers of the fluid conduit.

10. The method according to claim 7, wherein the method comprises deducing a damaged physical condition of the fluid conduit from the detection of assessment of water ingress between multiple layers of the fluid conduit.

11. The method according to claim 1, wherein the fluid conduit is a subterranean pipeline.

12. The method according to claim 1, wherein the method comprises transmitting a wideband acoustic signal from the measurement apparatus, through a fluid which couples the measurement apparatus to at least a portion of the fluid conduit, wherein at least one wideband acoustic transducer does not directly physically contact the fluid conduit.

13. The method according to claim 1, comprising transmitting a wideband acoustic signal comprising a frequency chirp.

14. The method according to claim 13, comprising transmitting a wideband acoustic signal comprising a plurality of frequency chirps.

15. The method according to claim 14, comprising transmitting a wideband acoustic signal comprising a plurality of stacked frequency chirps.

16. The method according to claim 14, wherein the wideband acoustic signal comprises a first chirp having a first frequency range, and a second chirp having a second frequency range, higher than the first frequency range.

17. The method according to claim 16, wherein the first and second chirps overlap in time for greater than 50% of the duration of the first chirp.

18. The method according to claim 17, wherein the first and second chirps overlap in time for greater than 70% of the duration of the first chirp.

19. The method according to claim 18, wherein the first and second chirps overlap in time for greater than 80% of the duration of the first chirp.

20. The method according to claim 19, wherein the first and second chirps overlap in time for around 90% of the duration of the first chirp.

21. The method according to claim 1, comprising analysing the wideband acoustic data set by comparing the data set with a database of wideband acoustic data signatures.

22. The method according to claim 1, comprising analysing the frequency content of the wideband acoustic data set.

23. The method according to claim 1, comprising comparing the frequency content of the wideband acoustic data set with the frequency content of previously acquired acoustic data.

24. The method according to claim 23, comprising interrogating a database of wideband acoustic data collected from one or more tests performed on a fluid conduit of known condition.

25. A measurement apparatus for assessing a condition of a fluid conduit, the apparatus comprising:
a body and at least one wideband acoustic transducer disposed on the body;
wherein the apparatus is operable to:
transmit a wideband acoustic signal from the at least one transducer into a fluid volume coupled to the at least a portion of the fluid conduit;
receive a wideband acoustic signal at the at least one wideband acoustic transducer to obtain a wideband acoustic data set;
wherein the wideband acoustic signal comprises frequencies in the range of approximately 10 kHz to approximately 150 kHz;
wherein the apparatus is configured to be disposed internally of the fluid conduit.

26. The apparatus according to claim 25, wherein the wideband acoustic signal comprises a lower frequency of approximately 10 kHz, and an upper frequency of approximately 150 kHz, and distribution of frequencies between the upper and lower frequencies.

27. The apparatus according to claim 25 wherein the apparatus comprises a pipeline pig.

28. The apparatus according to claim 25, configured to transmit a wideband acoustic signal from the measurement apparatus, through a fluid which couples the measurement apparatus to at least a portion of the fluid conduit, wherein the at least one wideband acoustic transducer does not directly physically contact the fluid conduit.

29. The apparatus according to claim 25, comprising a transmission wideband acoustic transducer and a receiving wideband acoustic transducer.

30. The apparatus according to claim 25, comprising a plurality of pairs of transmitting/receiving wideband acoustic transducers.

31. The apparatus according to claim 25, wherein the wideband acoustic transducer comprises a composite transducer.

32. The apparatus according to claim 25, wherein the wideband acoustic transducer has a Q-factor of less than 5.0.

33. The apparatus according to claim 32, wherein the wideband acoustic transducer has a Q-factor of less than 2.0.

34. The apparatus according to claim 33, wherein the wideband acoustic transducer has a Q-factor of less than 1.5.

35. The apparatus according to claim 25, wherein the efficiency of the wideband acoustic transducer is greater than 50%.

36. The apparatus according to claim 35, wherein the efficiency of the wideband acoustic transducer is greater than 65%.

37. The apparatus according to claim 25, wherein the wideband acoustic transducer is selected to provide a substantially linear or linear acoustic response.

38. The apparatus according to claim 25, wherein the apparatus is operable to detect or assess the build-up and/or deposition of scale, sand, waxes, hydrates, or other solids on an interior of the fluid conduit.
